(19) United States
(12) Patent Application Publication
(10) Pub. No.: US 2024/0225356 A1
(43) Pub. Date: Jul. 11, 2024

(54) TOASTER

(71) Applicant: YANDONG HE, FOSHAN (CN)

(72) Inventor: YANDONG HE, FOSHAN (CN)

(21) Appl. No.: 18/110,459

(22) Filed: Feb. 16, 2023

(30) Foreign Application Priority Data
Jan. 5, 2023 (CN) 202320020963.2

(51) Int. Cl. A47J 37/08

(52) U.S. Cl. CPC A47J 37/0857

(57) ABSTRACT

A toaster includes a toaster body. The toaster body defines a plurality of toasting grooves. The plurality of toasting grooves is arranged from front to rear. Each of the toasting grooves extends from left to right. A toasting device is arranged in each of the toasting grooves. A support base is arranged on a lower end of a front side of the toaster body. A heating device is arranged on the support base. A heating box is detachably arranged on the heating device. The heating box is configured to fry or steam food, so that the toaster can not only toast bread, but also fry and steam other foods. Further, a first control panel and a second control panel are arranged on a top surface of the toaster body, which facilitates operation and saves space, and further makes a structure of the toaster compact.

### TECHNICAL FIELD

The present disclosure relates to a field of toaster technology, and in particular to a toaster with a compact structure and multiple functions.

### BACKGROUND

Toaster, also known as automatic bread slice toaster or bread toaster, is an electric kitchenware specially designed to re-bake bread cut into slices. The toaster not only toasts the slices of bread to a burnt brown color, but also makes the slices of bread more aromatic and tasty and enhances appetite. The toaster is an appliance that specializes in toasting the bread. The bread toasted by the toaster is crispy and is toasted to different textures as needed. A breakfast prepared at home is generally toasted bread with a glass of milk. A user can also paste peanut butter, milk, or cheese on the toasted bread according to personal taste after the bread is toasted. With development of society, small appliances gradually into life of public, and let the public's way of life gradually change and become more convenient, so the public can easily enjoy life.

Conventional toasters generally only simply toast the bread to make the bread taste better. However, a structure of the conventional toasters is generally simple, and functions thereof are relatively single. Although there are multifunctional toasters on the market, function modules of the multifunctional toasters are arranged side-by-side, making an overall size of the multifunctional toasters larger and less compact, which is very inconvenient to place, store, package and transport. Therefore, it is necessary to improve the toasters in the prior art.

### SUMMARY

In view of this, a main purpose of the present disclosure is to provide a toaster with a compact structure and multiple functions, which effectively solves a problem of large size and uncompact structure of conventional toasters.

To achieve the above purpose, the present disclosure provides the toaster with the compact structure and multiple functions. The toaster comprises a toaster body. The toaster body defines a plurality of toasting grooves. The plurality of toasting grooves is arranged from front to rear. Each of the toasting grooves extends from left to right. A toasting device is arranged in each of the toasting grooves. A support base is arranged on a lower end of a front side of the toaster body. The support base extends forwards. A heating device is arranged on the support base. A heating box is detachably arranged on the heating device. A first control panel configured to control each toasting device and a second control panel configured to control the heating device are arranged on a top surface of the toaster body. The first control panel and the second control panel are arranged adjacent to the plurality of toasting grooves.

In one optional embodiment, the toaster body comprises a bottom shell. The support base comprises a bottom cover and a main body. The bottom cover is integrally formed with the bottom shell. The bottom cover extends forwards from a front side of the bottom shell. The main body is arranged on the bottom cover. An upper surface of the main body recesses to form a concave cavity. The heating device is embedded in the concave cavity to limit a position of the heating device. The heating box is embedded in the concave cavity to be positioned and contacts the heating device, so the heating box is stably arranged.

In one optional embodiment, the heating device comprises a heating plate and a heating pipe. An upper surface of the heating plate is attached to a bottom surface of the heating box. The heating pipe is welded on a lower surface of the heating plate. The heating pipe is electrically connected to the second control panel. The heating device has a simple structure, fast heating speed and high efficiency.

In one optional embodiment, the heating box comprises a box body, a steaming rack, and a box cover. The box body defines an accommodating cavity. The accommodating cavity defines an opening facing upwards. The steaming rack is detachably arranged in the accommodating cavity, so eggs can be placed on the steaming rack for steaming. The box cover is detachably arranged on the box body and covers the opening of the accommodating cavity.

In one optional embodiment, a handle is detachably arranged on a middle of a front side of the box body. The handle extends forwards, so the box body is lifted by the handle. Further, the handle is removed as needed to save space for storage.

In one optional embodiment, a connecting piece is riveted to the front side of the box body. A clamping groove defining a downward opening is formed between the connecting piece and the front side of the box body. A clamping sheet is arranged on a connecting end of the handle. The clamping sheet is matched with the clamping groove. The clamping sheet is inserted into the clamping groove from bottom to top and is limited in the clamping groove. The handle has a simple structure and is easy to assemble.

In one optional embodiment, the connecting piece defines two limiting holes. The two limiting holes are symmetrically arranged from left to right relative to an axial direction of the handle. The clamping sheet comprises two elastic limiting bars. The two elastic limiting bars are respectively clamped in the limiting holes for positioning, making connection thereof stable.

In one optional embodiment, a lifting handle is arranged on a middle of a top portion of the box cover, so the box cover is convenient to lift from or cover on the box cover.

In one optional embodiment, the first control panel and the second control panel are arranged from rear to front and are arranged on a same side of the plurality of toasting grooves, so the toaster is convenient to operate.

Compared with the prior art, in the present disclosure, the support base is arranged on the lower end of the front side of the toaster body, the heating device is arranged on the support base, and the heating box is detachably arranged on the heating device. The heating box is configured to fry or steam food, so that the toaster can not only toast bread, but also fry and steam other foods, and thus the toaster has multiple functions. Further, the first control panel and the second control panel are arranged on the top surface of the toaster body, which facilitates operation and saves space, and further makes a structure of the toaster compact. Therefore, the toaster is convenient to place, store, package and transport, and brings convenience to both users and manufacturers.

In order to clearly illustrate structural features and efficacy of the present disclosure, the present disclosure will be further described according to attached drawings and specific embodiments.

### BRIEF DESCRIPTION OF DRAWINGS

FIG. 1 is a perspective schematic diagram of a toaster according to one optional embodiment of the present disclosure.

FIG. 2 is another perspective schematic diagram of the toaster according to one optional embodiment of the present disclosure.

FIG. 3 is an exploded perspective schematic diagram of the toaster according to one optional embodiment of the present disclosure.

FIG. 4 is another exploded perspective schematic diagram of the toaster according to one optional embodiment of the present disclosure.

FIG. 5 is another exploded perspective schematic diagram of the toaster according to one optional embodiment of the present disclosure.

In the drawings:

10. toaster body; 11. toasting groove; 12. toasting device; 13. bottom shell; 20. support base; 21. bottom cover; 22. main body; 201. concave cavity; 30: heating device; 31. heating plate; 32. heating pipe; 40. heating box; 41. box body; 42. steaming rack; 43. box cover; 44. handle; 441. clamping sheet; 45. connecting piece; 401: accommodating cavity; 402. lifting handle; 403: clamping groove 404. limiting hole; 405: elastic limiting bar; 50. first control panel; 60. second control panel.

### DETAILED DESCRIPTION

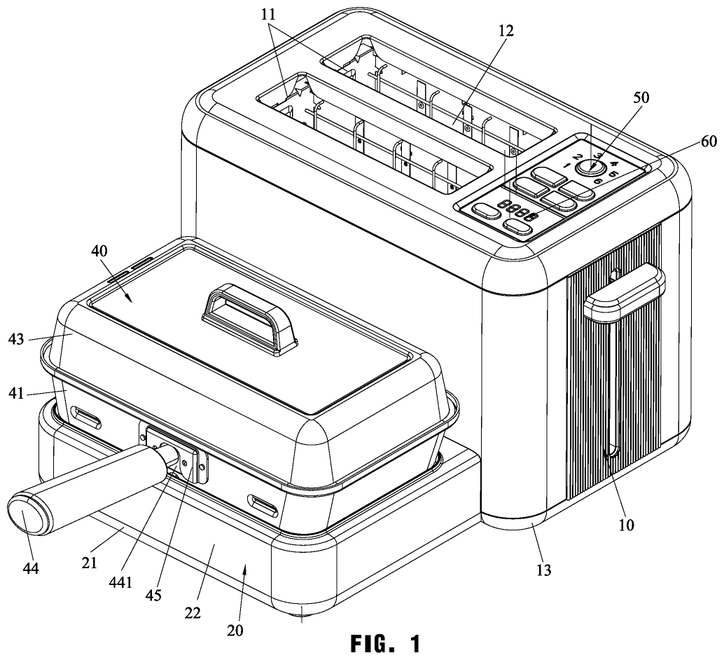

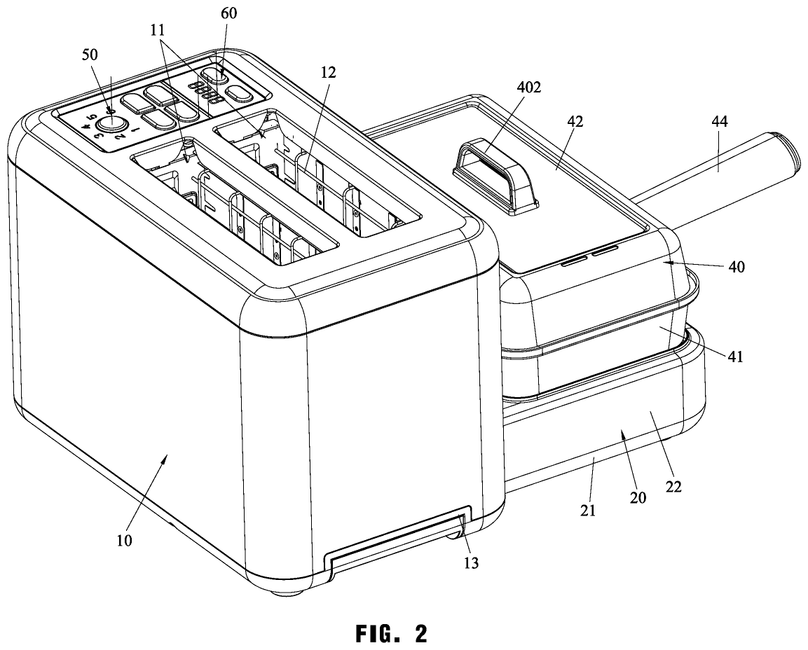

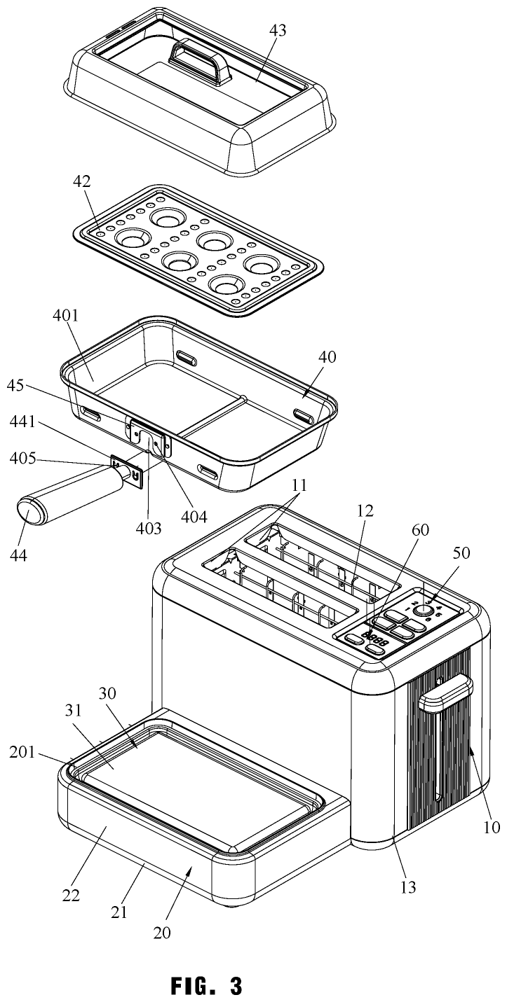

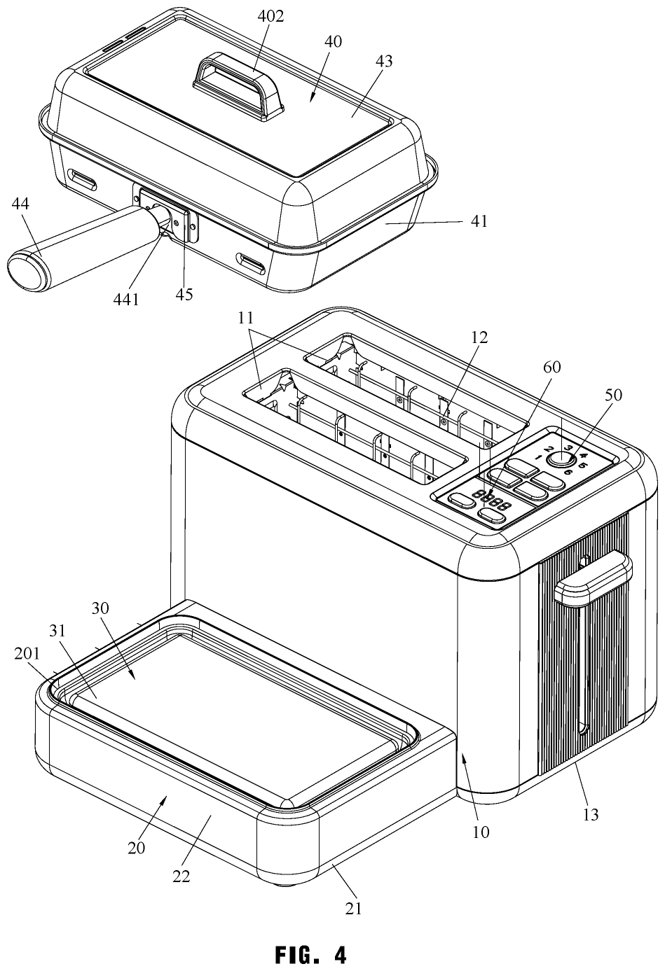

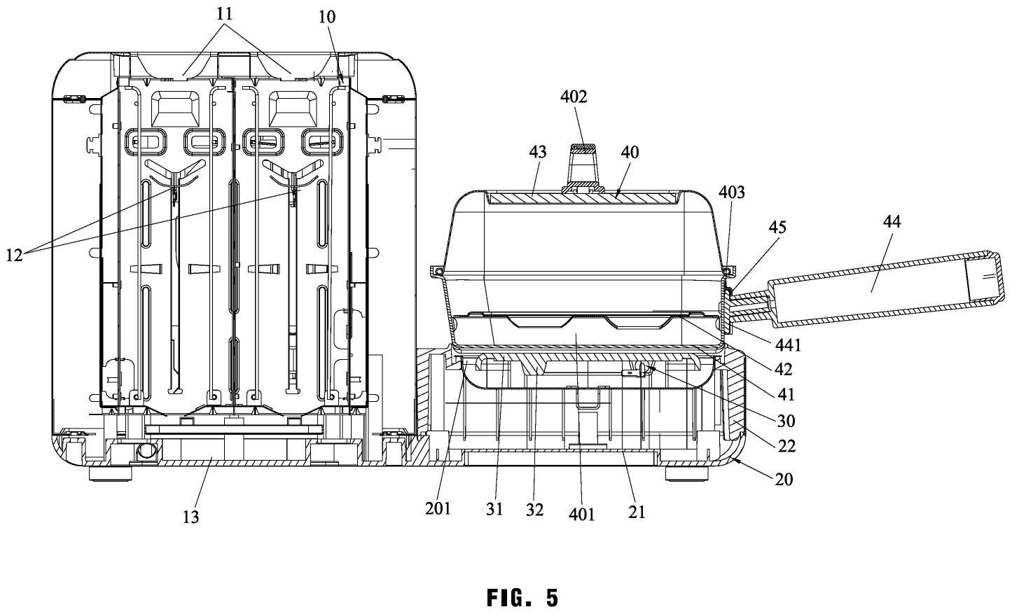

As shown in FIGS. 1-5, a specific structure of a toaster according to one optional embodiment of the present disclosure is shown.

The toaster comprises a toaster body 10. The toaster body 10 defines a plurality of toasting grooves 11. The plurality of toasting grooves 11 is arranged from front to rear. Each of the toasting grooves 11 extends from left to right. A toasting device 12 is arranged in each of the toasting grooves 11. In the embodiment, two toasting grooves 11 are provided, and the number of toasting grooves is not limited thereto. The toaster body 10 comprises a bottom shell 13.

A support base 20 is arranged on a lower end of a front side of the toaster body 10. The support base 20 extends forwards. A heating device 30 is arranged on the support base 20. A heating box 40 is detachably arranged on the heating device 30. A first control panel 50 configured to control each toasting device 12 and a second control panel 60 configured to control the heating device 30 are arranged on a top surface of the toaster body 10.

Specifically, the support base 20 comprises a bottom cover 21 and a main body 22. The bottom cover 21 is integrally formed with the bottom shell 13. The bottom cover 21 extends forwards from a front side of the bottom shell 13 to form a one-piece structure. The main body 22 is arranged on the bottom cover 21. An upper surface of the main body 22 recesses to form a concave cavity 201. The heating device 30 is embedded in the concave cavity 201 to limit a position of the heating device 30. The heating box 40 is embedded in the concave cavity 201 to be positioned and contacts the heating device 30, so the heating box 40 is stably arranged.

The heating device 30 comprises a heating plate 31 and a heating pipe 32. An upper surface of the heating plate 31 is attached to a bottom surface of the heating box 40. The heating pipe 32 is welded on a lower surface of the heating plate 31. The heating pipe 32 is electrically connected to the second control panel 60. The heating device 30 has a simple structure, fast heating speed and high efficiency.

The heating box 40 comprises a box body 41, a steaming rack 42, and a box cover 43. The box body 41 defines an accommodating cavity 401. The accommodating cavity 401 defines an opening facing upwards. A bottom surface of one end of the accommodating cavity 401 is flat. The steaming rack 42 is detachably arranged in the accommodating cavity 401, so eggs can be placed on the steaming rack 42 for steaming. The box cover 43 is detachably arranged on the box body 41 and covers the opening of the accommodating cavity 401. A lifting handle 402 is arranged on a middle of a top portion of the box cover 43, so the box cover 43 is convenient to lift from or cover on the box cover 43.

A handle 44 is detachably arranged on a middle of a front side of the box body 41. The handle 44 extends forwards, so the box body 41 is lifted by the handle 44. Further, the handle 44 is removed as needed to save space for storage. Specifically, a connecting piece 45 is riveted to the front side of the box body 41. A clamping groove 403 defining a downward opening is formed between the connecting piece 45 and the front side of the box body 41. A clamping sheet 441 is arranged on a connecting end of the handle 44. The clamping sheet 441 is matched with the clamping groove 403. The clamping sheet 441 is inserted into the clamping groove 403 from bottom to top and is limited in the clamping groove 403. The handle 44 has a simple structure and is easy to assemble.

Furthermore, in the embodiment, the connecting piece 45 defines two limiting holes 404. The two limiting holes 404 are symmetrically arranged from left to right relative to an axial direction of the handle 44. The clamping sheet 441 comprises two elastic limiting bars 405. The two elastic limiting bars 405 are respectively clamped in the limiting holes 404 for positioning, making connection thereof stable. When the handle 44 is in use, the clamping sheet 441 of the handle 44 is inserted into and limited in the clamping groove 403 from bottom to top, so that the two elastic limiting bars 405 are respectively limited in the limiting holes 404 to realize an installation of the handle 44. When the handle 44 is not in use, the handle 44 is removed by pressing the handle 44 downward relative to the box body 41, so that the two elastic limiting bars 405 are released from the limiting holes 404, and the handle 44 is able to be placed in the accommodating cavity 401 for storage, which is very convenient.

The first control panel 50 and the second control panel 60 are arranged from rear to front and are arranged on a same side of the plurality of toasting grooves 11, so the toaster is convenient to operate.

A working principle of the toaster of the present disclosure is as follow.

When it is necessary to toast bread slices, the bread slices are inserted into corresponding toasting grooves 11, and then each toasting device is controlled to work through the first control panel 50, and the bread slices are toasted by the corresponding toasting devices 12.

When it is necessary to fry bacon, eggs, etc., the handle 44 is connected to the box body 41, and the handle 44 is lifted to place the heating box 40 on the heating device 30. Then the box cover 43 and the steaming rack 42 are removed. The second control panel 60 is then operated to control the heating device 30 to work to heat the box body 41. At this time, the bacon, eggs, etc. can be put into the box body 41 for frying.

When it is necessary to steam the eggs and other food, an appropriate amount of water is added into the accommodating cavity 401, the steaming rack is placed in the accommodating cavity, and then the eggs and other fool are placed on the steaming rack 42. Then the box cover 43 is covered on the box body 41. The second control panel 60 is operated to turn on the heating device 30, and the heating device 30 works to heat the box body 41, so the eggs and other food are steamed.

In the present disclosure, the support base is arranged on the lower end of the front side of the toaster body, the heating device is arranged on the support base, and the heating box is detachably arranged on the heating device. The heating box is configured to fry or steam food, so that the toaster can not only toast bread, but also fry and steam other foods, and thus the toaster has multiple functions. Further, the first control panel and the second control panel are arranged on the top surface of the toaster body, which facilitates operation and saves space, and further makes a structure of the toaster compact. Therefore, the toaster is convenient to place, store, package and transport, and brings convenience to both users and manufacturers.

Foregoing descriptions are only optional embodiments of the present disclosure and are not intended to limit the present disclosure. Any minor modification, equivalent replacement, or improvement made to the above embodiments based on the technical substance of the present disclosure should be included in the protection scope of the present disclosure.

What is claimed is:

1. A toaster, comprising: a toaster body; wherein the toaster body defines a plurality of toasting grooves; the plurality of toasting grooves is arranged from front to rear; each of the toasting grooves extends from left to right; a toasting device is arranged in each of the toasting grooves; a support base is arranged on a lower end of a front side of the toaster body; the support base extends forwards; a heating device is arranged on the support base; a heating box is detachably arranged on the heating device; a first control panel configured to control each toasting device and a second control panel configured to control the heating device are arranged on a top surface of the toaster body; the first control panel and the second control panel are arranged adjacent to the plurality of toasting grooves.

2. The toaster according to claim 1, wherein the toaster body comprises a bottom shell; the support base comprises a bottom cover and a main body; the bottom cover is integrally formed with the bottom shell; the bottom cover extends forwards from a front side of the bottom shell; the main body is arranged on the bottom cover; an upper surface of the main body recesses to form a concave cavity; the heating device is embedded in the concave cavity to limit a position of the heating device; the heating box is embedded in the concave cavity to be positioned and contacts the heating device.

3. The toaster according to claim 1, wherein the heating device comprises a heating plate and a heating pipe; an upper surface of the heating plate is attached to a bottom surface of the heating box; the heating pipe is welded on a lower surface of the heating plate; the heating pipe is electrically connected to the second control panel.

4. The toaster according to claim 1, wherein the heating box comprises a box body, a steaming rack, and a box cover; the box body defines an accommodating cavity; the accommodating cavity defines an opening facing upwards; the steaming rack is detachably arranged in the accommodating cavity; the box cover is detachably arranged on the box body and covers the opening of the accommodating cavity.

5. The toaster according to claim 4, wherein a handle is detachably arranged on a middle of a front side of the box body; the handle extends forwards.

6. The toaster according to claim 5, wherein a connecting piece is riveted to the front side of the box body; a clamping groove defining a downward opening is formed between the connecting piece and the front side of the box body; a clamping sheet is arranged on a connecting end of the handle; the clamping sheet is matched with the clamping groove; the clamping sheet is inserted into the clamping groove from bottom to top and is limited in the clamping groove.

7. The toaster according to claim 6, wherein the connecting piece defines two limiting holes; the two limiting holes are symmetrically arranged relative to an axial direction of the handle; the clamping sheet comprises two elastic limiting bars; the two elastic limiting bars are respectively clamped in the limiting holes for positioning.

8. The toaster according to claim 4, wherein a lifting handle is arranged on a middle of a top portion of the box cover.

9. The toaster according to claim 1, wherein the first control panel and the second control panel are arranged from rear to front and are arranged on a same side of the plurality of toasting grooves.
